(19) United States
(12) Patent Application Publication
(10) Pub. No.: US 2014/0294421 A1
(43) Pub. Date: Oct. 2, 2014

(54) IMAGE FORMING SYSTEM, INSTRUCTION OUTPUT CONTROL METHOD, AND RECORDING MEDIUM

(71) Applicants: Rina TAKAHASHI, Kanagawa (JP); Mina TSUKAHARA, Kanagawa (JP)

(72) Inventors: Rina TAKAHASHI, Kanagawa (JP); Mina TSUKAHARA, Kanagawa (JP)

(21) Appl. No.: 14/224,305

(22) Filed: Mar. 25, 2014

(30) Foreign Application Priority Data
Apr. 1, 2013 (JP) 2013-076001

(51) Int. Cl. G03G 15/00

(52) U.S. Cl. CPC G03G 15/5016
USPC 399/81

(57) ABSTRACT

An image forming system, an instruction output control method, and a non-transitory recording medium storing an instruction output control method, each of which obtains information indicating detection of a jam at an image forming system including an image forming apparatus and one or more peripheral devices, detects a current location of a user who is present near the image forming apparatus or the peripheral devices, determines a method of outputting a jam removal instruction to the user through a first display of the image forming apparatus based on the current user location, and causes the first display to display the jam removal instruction according to the determined jam removal instruction method.

### CROSS-REFERENCE TO RELATED APPLICATIONS

This patent application is based on and claims priority pursuant to 35 U.S.C. §119 to Japanese Patent Application No. 2013-076001, filed on Apr. 1, 2013, in the Japan Patent Office, the entire disclosure of which is hereby incorporated by reference herein.

### BACKGROUND

1. Technical Field

The present invention generally relates to an image forming system, a method of controlling output of an instruction, and a non-transitory recording medium storing an instruction output control program.

2. Description of the Related Art

The recent image forming apparatuses that form an image on a recording sheet, may be used together with a high-capacity sheet feeding device, and/or various post processing devices capable of applying post processing such as stapling, punching, sorting, folding, or binding, to configure an image forming system.

When a jam occurs at one of these devices in the image forming system, a user needs to take out jammed paper by hand. More specifically, the image forming apparatus is provided with an operation panel that displays a specific procedure to remove jammed paper, one step by one step in a predetermined order. According to this jam removal instruction, the user is able to remove jammed paper without damaging the device or jammed paper.

However, the inventors of the present invention have discovered that, when the entire length of the image forming system is relatively long due to the increased number of devices, the user may be required to keep moving from one location to another location, until the jam removal procedure completes. Especially when there is more than one jam, it may be cumbersome for the user to walk a long distance to remove jammed paper from more than one location.

### SUMMARY

Example embodiments of the present invention include an image forming system, an instruction output control method, and a non-transitory recording medium storing an instruction output control method, each of which obtains information indicating detection of a jam at an image forming system including an image forming apparatus and one or more peripheral devices, detects a current location of a user who is present near the image forming apparatus or the peripheral devices, determines a method of outputting a jam removal instruction to the user through a first display of the image forming apparatus based on the current user location, and causes the first display to display the jam removal instruction according to the determined jam removal instruction method.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a configuration of an image forming system including an image forming apparatus and one or more peripheral devices, according to an example embodiment of the present invention;

FIG. 2 is a schematic block diagram illustrating a functional structure of the image forming system of FIG. 1, according to an example embodiment of the present invention;

FIG. 3 is a schematic block diagram illustrating a hardware structure of a controller of the image forming apparatus of FIG. 2, according to an example embodiment of the present invention;

FIG. 4 is a flowchart illustrating operation of determining a jam removal instruction method, performed by the image forming apparatus of FIG. 2, according to an example embodiment of the present invention;

FIG. 5 is a flowchart illustrating operation of selecting an operation panel to output a jam removal instruction, performed by the image forming apparatus of FIG. 2, according to an example embodiment of the present invention;

FIG. 6 is a flowchart illustrating operation of changing an angle of an operation panel, performed by the image forming apparatus of FIG. 2, according to an example embodiment of the present invention;

FIG. 7 is a schematic block diagram illustrating a functional structure of an image forming system including an image forming apparatus and one or more peripheral devices, according to an example embodiment of the present invention;

FIG. 8 is a flowchart illustrating operation of determining a jam removal instruction method, performed by the image forming apparatus of FIG. 7, according to an example embodiment of the present invention;

FIG. 9 is a schematic block diagram illustrating a functional structure of an image forming system including an image forming apparatus and one or more peripheral devices, according to an example embodiment of the present invention; and

FIG. 10 is a flowchart illustrating operation of determining a jam removal instruction method, performed by the image forming apparatus of FIG. 9, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

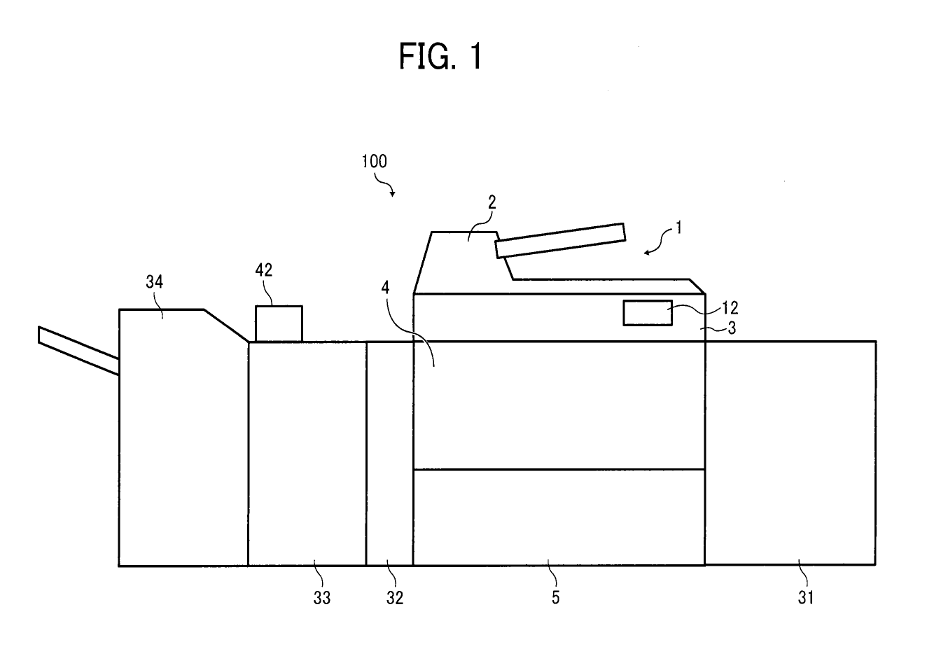

Referring now to FIGS. 1 to 3, a configuration of an image forming system 100 is explained according to an example embodiment of the present invention.

The image forming system 100 of FIG. 1 includes an image forming apparatus 1, which is connected to a high-capacity sheet feeding device 31, and a plurality of post processing devices 32, 33, and 34, through any desired communication means such as a wired or wireless network. In this example, any one of the sheet feeding device 31 and the post processing devices 32 to 34 may each or collectively be referred to as a peripheral device 30.

In this example illustrated in FIG. 1, the image forming apparatus 1 is implemented by a multifunctional printer (MFP) provided with a plurality of functions including printing, copying, scanning, and/or facsimile communication. More specifically, the image forming apparatus 1 includes an automatic document feeder (ADF) 2, a scanner 3, a printer 4, and a sheet feeding unit 5.

The ADF 2 conveys the original document, one page by one page, to an image reading section of the scanner 3. More specifically, the ADF 2 conveys the original document, placed on a document tray, one page by one page, with an ADF motor toward a contact glass of the scanner 3, which is placed between the ADF 2 and the scanner 3. As the original image is being read by the scanner 3, the original document is conveyed with the ADF motor and discharged onto a discharge tray, which is provided above the contact glass.

The scanner 3 mainly includes the contact glass on which the original document may be placed, and an optical scanning system. The optical scanning system includes an exposure lamp, a first mirror, a second mirror, a third mirror, a lens system, and a full-color charged coupled device (CCD). The exposure lamp and the first mirror, which is mounted on a first carriage, is moved by a scanner motor in a sub-scanning direction, at a constant speed, to scan the original image. The second mirror and the third mirror, which is mounted on a second carriage, is moved by the scanner motor at a speed that is about half of the speed of the first carriage, to scan the original image. With the movements of the first carriage and the second carriage, the image surface of the original image is optically scanned by the optical scanning system, thus forming an image on the light receiving surface of the CCD by the lens system. The CCD converts from the optical image to the electric signal to generate image data. In this manner, the scanner 3 reads the original image into the electric signal, i.e., the image data.

The printer 4 forms an image on a recording sheet, which is fed by the sheet feeding unit 5, based on the electric signal, i.e., the image data generated by the scanner 3. The printer 4 includes drum-like photoconductors of cyan, magenta, yellow, and black colors, an exposure device, and an intermediate transfer belt. Along the circumferential direction of each photoconductor, a cleaner, discharger, charger, and developer are provided. The exposure device irradiates a laser light, which is modulated based on the image data, onto the surface of the photoconductor to form a latent image thereon. With the developer, the latent image is developed into a toner image. The toner image is transferred onto a surface of the intermediate transfer belt, as the photoconductor and the intermediate transfer belt rotate. More specifically, on the surface of the intermediate transfer belt, which is an endless belt, toner images of the respective colors of yellow, magenta, cyan, and black are superimposed one above the other to form a full-color image. The full-color toner image is transferred onto a recording sheet at a secondary transfer nip. The recording sheet having the image formed thereon is further conveyed to a nip formed by two rollers of a fixing device. At the fixing device, the toner image is fixed onto the recoding sheet with heat and pressure. The recording sheet having the image may be transferred to the post processing devices 32, 33, and 34 for further processing.

Alternatively, the image forming apparatus 1 may be implemented by any desired printer. The image forming apparatus 1 is capable of forming an image on any desired recording sheet, using any desired image forming method. Examples of recording sheet include, but not limited to, paper such as plain paper, thick paper, gloss paper, coat paper, and mat paper, and film transfer sheet such as OHP. Examples of image forming method include, but not limited to, electrophotographic printing as described above, and ink-jet printing in which a print head applies ink to a recording sheet.

While the image forming apparatus 1 may be used alone to print out an image, with the peripheral device 30, a large number of printed images may be output with improved efficiency. Especially in the production printing, the image forming system 100 as illustrated in FIG. 1 is widely used, with the increased needs for small-lot production and variable printing. In such case, it is desired to have the image forming system capable of printing a large number of high-quality images with the increased speeds.

More specifically, the image forming apparatus 1 usually has a photoconductor with a larger diameter size. To handle a large amount of supply, the sheet feeding device 31 capable of storing a large number of recording sheets therein, and a toner supply device may be provided upstream of the image forming apparatus 1. The post processing devices may be provided downstream of the image forming apparatus 1, for example, to apply post processing to printed sheets such as binding to make booklets. More specifically, in this example, the folder 32, the stacker 33, and the finisher 34 may be connected to the image forming apparatus 1. The folder 32 folds the printed sheets in two or in Z form. The stacker 33 stacks therein the printed sheets, which are output from the image forming apparatus 1. The finisher 34 is capable of stapling a plurality of printed sheets, for example, into one booklet. The recording sheets that are processed by these devices 32 to 34 are output onto a tray of the finisher 34. The other examples of post processing device include an insert feeder that inserts a front/back cover sheet or a slip sheet, a stacker having a cart capable of stacking and carrying a large number of sheets or booklets, a ring binder, and a cooling device that cools the printed sheets. Thus, processing to be performed by the image forming system 100 varies depending on specific devices functioning as the peripheral device 30, or specific instructions that are previously given to the image forming apparatus 1.

In one example, the printed sheets, which are the sheets fed by the sheet feeding device 31 and printed by the image forming apparatus 1, are folded by the folder 32 to be stacked in the stacker 33. The sheets are then transferred to the finisher 34 to be aligned and stapled together into a booklet, and discharged onto the tray of the finisher 34.

In another example, the printed sheets, which are the sheets fed by the sheet feeding device 31 and printed by the image forming apparatus 1, are transferred to the stacker 33 via the folder 32, and stacked in the stacker 33.

To control image forming and post processing operation performed by the image forming system 100, the user may be notified of various information through an operation panel provided for the image forming system 100. In this example, it is assumed that an operation panel 12 is provided at any portion of the image forming apparatus 1, and an operation panel 42 is provided at any portion of the peripheral device 30. Alternatively, one operation panel may be provided at any location, which is capable of controlling entire operation of the image forming system 100, as long as the operation panel is capable of controlling operation of the image forming system 100, for example, through a network. Alternatively, more than one operation panel may be provided for the peripheral device 30.

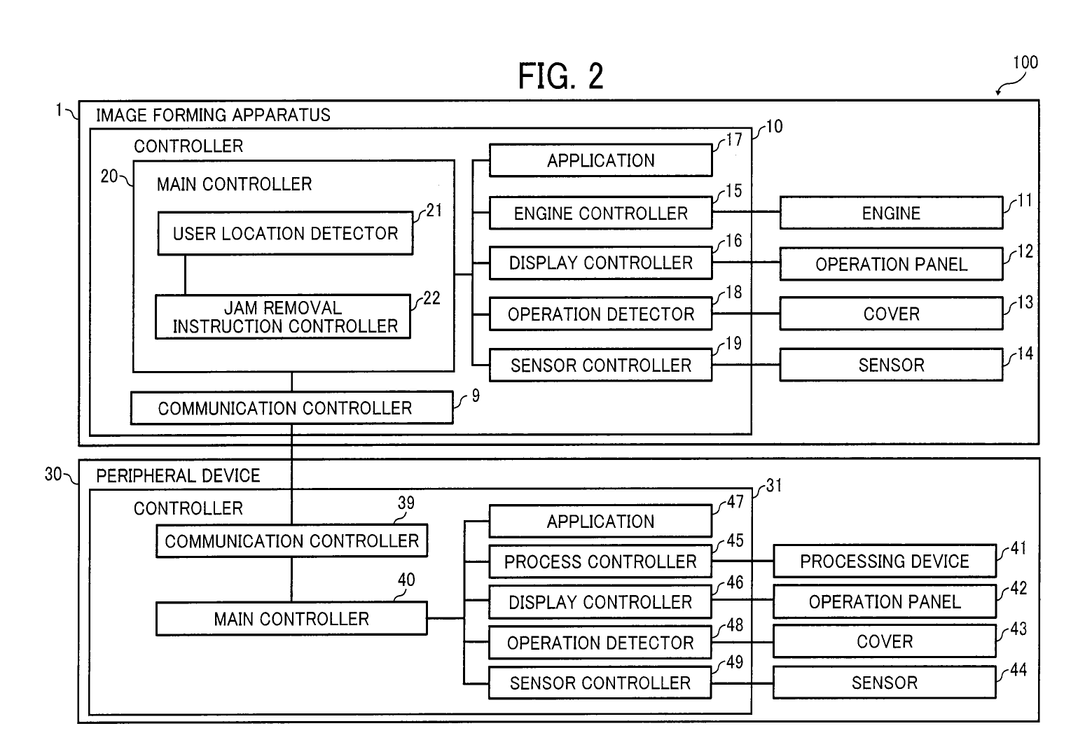

Referring now to FIG. 2, functional structures of the image forming apparatus 1 and the peripheral device 30 are explained according to an example embodiment of the present invention.

The image forming apparatus 1 mainly includes a controller 10, an engine 11, the operation panel 12, a cover 13, and a sensor 14.

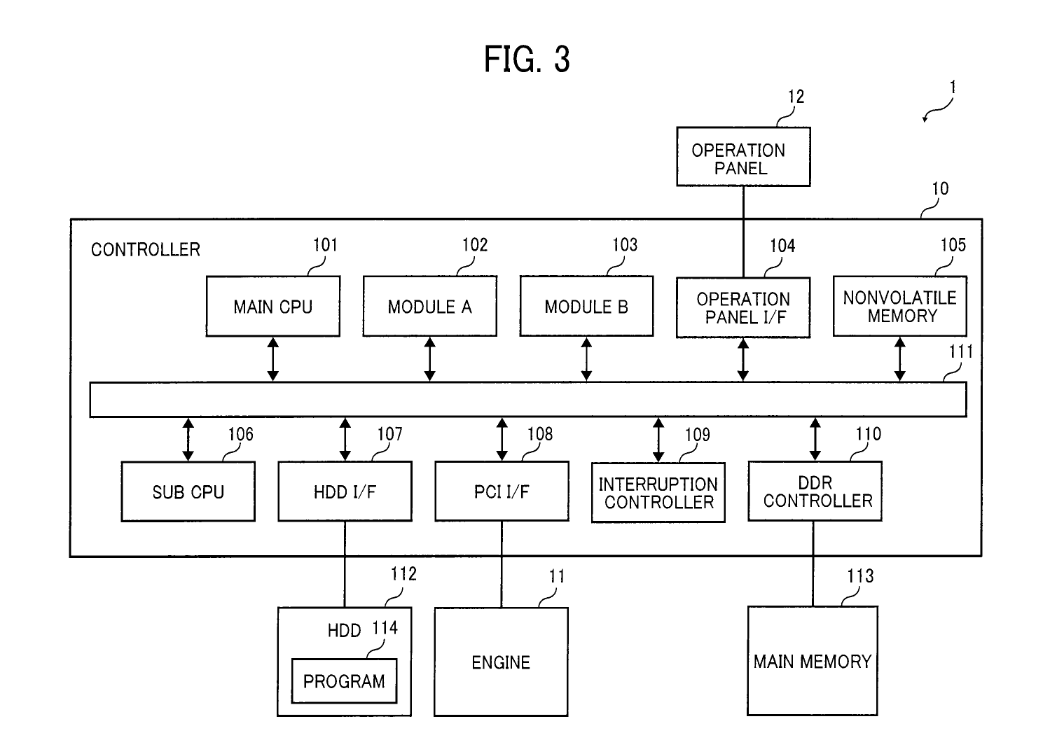

The controller 10, which may be referred to as a printer controller, controls entire operation of the image forming apparatus 1. The controller 10 includes a central processing unit (CPU), a read only memory (ROM) that stores various programs for execution by the CPU, and a random access memory (RAM) that stores various data, which may be connected through a bus. In this example, it is assumed that the controller 10 has a hardware structure as described below referring to FIG. 3.

The controller 10 includes a main controller 20 including a user location detector 21 and a jam removal instruction controller 22, a communication controller 9, an application 17, an engine controller 15, a display controller 16, an operation detector 18, and a sensor controller 19. The main controller 20 controls entire operation of the image forming apparatus 1 via the controller 10. The engine controller 15 controls operation of the engine 11, such as through sending an image forming instruction to the engine 11. The display controller 16 controls operation of the operation panel 12. The application 17 includes various applications to realize various functions of the image forming apparatus 1, such as printer application, scanner application, facsimile application, etc. The operation detector 18 detects opening or closing of the cover 13. The sensor controller 19 controls operation of the sensor 14. The communication controller 9 allows the image forming apparatus 1 to communicate with the outside apparatus such as the peripheral device 30 through, for example, a network.

The engine 11, which corresponds to the printer 4 of FIG. 1, forms an image on a recording sheet. As described above referring to FIG. 1, the printer 4 includes various devices that form an image.

The operation panel 12 allows a user to input various instructions through various keys or a touch panel, or displays various information for display to the user through a display. The operation panel 12 includes, for example, a liquid crystal display (LCD) that displays information. The LCD may function as a touch panel, which receives a user input. The operation panel 12 may be provided with various keys, which allow the user to operate.

Alternatively, the operation panel 12 may be made removable from the body of the image forming apparatus 1, such that the operation panel 12 may communicate with the image forming apparatus 1 via a wireless network. With this structure, the user is able to remotely control the image forming apparatus 1 through the operation panel 12. In such case, the display controller 16 detects the location of the operation panel 12, and sends the detection result to the user location detector 21 as the current user location. The operation panel 12 and the display controller 16 together provide the function of detecting the user location.

Further, in this example, the operation panel 12 may be rotated by any desired angle to change a direction to which the display faces. More specifically, the display controller 16 may change the angle of the operation panel 12 according to an instruction received from the jam removal instruction controller 22. For example, when the current user location is near the operation panel 12, the operation panel 12 may be rotated to be at a position such that the display of the operation panel 12 is in front of the user. With this configuration, the user can easily see information displayed on the operation panel 12.

The operation panel 12 may be additionally provided with a sound output device such as a speaker, which outputs sounds under control of the display controller 16. For example, the display controller 16 may instruct the speaker to output a jam removal instruction by voice navigation, which is previously prepared and stored in the memory of the image forming apparatus 1.

The cover 13 corresponds to one or more covers or doors, each of which is provided to cover the inside of the image forming apparatus 1 when it is closed. When it is opened, the inside of the image forming apparatus 1 is exposed to the user, such that the user can access inside of the image forming apparatus 1, for example, to take out jammed paper. For example, the cover 13 includes an upper side cover, a back side cover, a double-sided cover, etc. When a jam is detected, the user is notified of a specific cover 13 to be opened from the operation panel 12, to take out jammed paper from the inside of the image forming apparatus 1. In the following, opening or closing of the cover 13 may be detected by a sensor, which is provided for each cover to detect opening or closing of the cover 13.

The sensor 14 may be a sensor of any desired type, which is capable of detecting the human presence near the image forming apparatus 1. For example, the sensor 14 may detect the human presence using infrared light, ultrasonic wave, or visible light. In this example, the sensor 14 is capable of detecting the human presence in a range of 1 meter around the image forming apparatus 1.

In addition to the sensor 14 that detects the human presence, the image forming apparatus 1 includes a sensor that detects the presence of jammed paper, for example, along a sheet transfer path of the image forming apparatus 1. Based on the sensor output, the controller 10 determines that a jam is detected at a location where the sensor is provided.

Still referring to FIG. 2, the peripheral device 30, such as the sheet feeding device 31 or the post processing devices 32 to 34, includes a controller 31, a processing device 41, an operation panel 42, a cover 43, and a sensor 44.

The controller 40 controls entire operation of the peripheral device 30, and includes a main controller 40, a communication controller 39, an application 47, a process controller 45, a display controller 46, an operation detector 48, and a sensor controller 49. The controller 31 is substantially similar in hardware structure to the controller 10. The main controller 40 controls entire operation of the peripheral device 30 via the controller 31. The application 47 includes various applications to realize various functions of the peripheral device 30, such as post-processing application. The process controller 45 controls operation of the processing device 41, such as to perform various functions specific to the peripheral device 30. The display controller 46 controls operation of the operation panel 42. The operation detector 48 detects opening or closing of the cover 43. The sensor controller 49 controls operation of the sensor 44. The communication controller 39 allows the peripheral device 30 to communicate with the outside apparatus such as the image forming apparatus 1 through, for example, a network.

The processing device 41 performs processing, such as post processing, on the recording sheet output from the image forming apparatus 1. For example, when the peripheral device 30 is implemented as the folder 31, the processing device 41 folds the recoding sheet output from the image forming apparatus 1, under control of the process controller 45.

The operation panel 42 is substantially similar in function to the operation panel 12 of the image forming apparatus 1. Alternatively, the operation panel 42 and the display controller 46 may not be provided for the peripheral device 30. In such case, the operation panel 12 may display information to be output through the peripheral device 30, or receive instruction from the peripheral device 30, under control of the display controller 16. More specifically, the main controller 20 transmits or receives information regarding the peripheral device 30 through the communication controller 9, and controls the display controller 16 to display information on the operation panel 12.

The cover 43 corresponds to one or more covers or doors, each of which is provided to cover the inside of the peripheral device 30 when it is closed. When it is opened, the inside of the peripheral device 30 is exposed to the user, such that the user can access inside of the peripheral device 30, for example, to take out jammed paper. When a jam is detected, the user is notified of a specific cover 43 to be opened from the operation panel 42, to take out jammed paper from the inside of the peripheral device 30. In case the operation panel 42 is not provided, the operation panel 12 may notify the user of the specific cover 43 to be opened. As described above, opening or closing of the cover 43 may be detected by a sensor provided for each cover 43.

The sensor 44 is substantially similar in function to the sensor 14 of the image forming apparatus 1, such that the sensor 44 detects the human presence near the peripheral device 30 and sends the detection result to the sensor controller 49. In addition, the sensor 44 may include a sensor that detects the presence of jammed paper, for example, along a sheet transfer path of the peripheral device 30. Based on the sensor output, the controller 31 determines that a jam is detected at a location where the sensor is provided.

As described above, the main controller 20 of the image forming apparatus 1 includes the user location detector 21 and the jam removal instruction controller 22. The user location detector 21 obtains information indicating the current location of the user, for example, based on data output from the sensor 14 of the image forming apparatus 1 and/or data output from the sensor 44 of the peripheral device 30. In this example, a plurality of sensors is provided at the image forming apparatus 1 and the peripheral device 30, such that the current location of the user who operates the image forming system 100 can be detected. To detect the current user location using a plurality of sensor outputs, the user location detector 21 may perform calculation to estimate a specific location of the user.

In another example, the user location detector 21 obtains information indicating the current location of the user, for example, based on opening or closing of the cover 13 of the image forming apparatus 1 via the operation detector 18, or the cover 43 of the peripheral device 30 via the operation detector 48. Based on the received data indicating opening or closing of the cover 13 or 43, the user location detector 21 estimates that the user is present at a location where the cover 13 or 43 is provided.

As described above, the operation panel 12 or 42 may be removed from the body of the image forming apparatus 1 or the body of the peripheral device 30. In such case, the user location detector 21 receives the current location of the operation panel 12 or 42 from the display controller 16, and estimates that the user is present at a location where the operation panel 12 or 42 is provided. Further, the user location detector 21 may receive a user instruction through the operation panel 12 or 42 through the touch panel or keys provided for the operation panel 12 or 42. In such case, it is assumed that the user is present at a location where the operation panel 12 or 42 is provided.

The user location detector 21, which detects the current user location, sends the detection result indicating the current user location to the jam removal instruction controller 22. Based on the detected user location, the jam removal instruction controller 22 selects a method of instructing a jam removal procedure, and causes the display controller 16 to output a jam removal instruction using the selected instruction method.

In this example, it is assumed that the jam removal instruction is given to the user, one step by one step, in an order previously determined based on a priority assigned to each step. More specifically, the image forming apparatus 1 stores a plurality of jam removal instructions, each indicating specific steps to be performed to remove a jam that has been detected at a specific jam location. The jam removal instruction may be stored in association with information that may be used for identifying a type of jam, such as jam location information. For example, when the jam is detected at a specific location based on the sensor output from the sensor, the jam removal instruction controller 22 obtains a jam removal instruction that is stored in association with the detected jam location. According to the obtained jam removal instruction, the jam removal instruction controller 22 instructs the display controller 16 to display the jam removal instruction, one step by one step, on the operation panel 12, until it is determined that the jammed paper is removed based on the sensor output indicating the absence of jammed paper. In this example, the jam removal instruction may be selected based on the current user location.

In one example, when the peripheral device 30 is provided with the operation panel 42 and the display controller 46, the jam removal instruction controller 22 selects one of the operation panels 12 and 42, which is close to the current user location, and causes the selected operation panel 12 or 42 to display the jam removal instruction indicating a jam removal procedure.

In another example, when the peripheral device 30 is not provided with the operation panel 42 and the display controller 46, the operation panel 12 of the image forming apparatus 1 functions as an operation panel for the entire image forming system 100. In such case, the jam removal instruction controller 22 determines whether the operation panel 12 can change its angle. When it is determined that the operation panel 12 can be rotated to change its angle, the jam removal instruction controller 22 changes the angle of the operation panel 12 so as to make the display screen of the operation panel 12 face the current user location. More specifically, the jam removal instruction controller 22 obtains a straight line that passes through the operation panel location and the current user location, and changes the angle of the operation panel 12 such that a line perpendicular to the display screen surface of the operation panel 12 coincides with the obtained straight line. After rotating the operation panel 12, the jam removal instruction controller 22 instructs the display controller 16 to cause the operation panel 12 to output the jam removal instruction.

In another example, when the peripheral device 30 is not provided with the operation panel 42 and the display controller 46, the operation panel 12 of the image forming apparatus 1 functions as an operation panel for the entire image forming system 100. In such case, the jam removal instruction controller 22 determines whether the operation panel 12 is provided with a sound output device capable of outputting sounds. When it is determined that the operation panel 12 is provided with the sound output device, the jam removal instruction controller 22 may further determine whether the current user location is far from the location of the operation panel 12, for example, by determining whether a distance between the current user location and the operation panel location is greater than a threshold value. When it is determined that the current user location is far from the operation panel location, the jam removal instruction controller 22 may start outputting the jam removal instruction by voice navigation, in alternative to or in addition to display of the jam removal instruction.

The jam removal instruction may be given in various other ways. For example, in case more than one operation panel is provided for the image forming system 100, such as when the peripheral device 30 is provided with the operation panel 42 and the display controller 46, the jam removal instruction controller 22 may additionally change the angle of the operation panel after selecting the operation panel for display based on the current user location. In a substantially similar manner, the jam removal instruction controller 22 may additionally cause the operation panel to output the jam removal instruction by voice navigation after selecting the operation panel for display based on the current user location. The above-described selection of the operation panel for output, changing the angle of the operation panel, and turning on voice navigation may be performed in any combination.

Referring now to FIG. 3, a hardware structure of the controller 10 of the image forming apparatus 1 is explained according to an example embodiment of the present invention. The controller 10 may be implemented by, for example, a system on chip (SOC) or ASIC.

The controller 10 includes a main CPU 101, a module A 102, a module B 103, an operation panel interface (I/F) 104, a nonvolatile memory 105, a sub CPU 106, a HDD I/F 107, a peripheral component interconnect (PCI) I/F 108, an interruption controller 109, and a DDR controller 110, which are connected through a bus 111. In addition to the controller 10, the image forming apparatus 1 includes various devices illustrated in FIG. 2 such as the engine 11 and the operation panel 12, and the other devices such as a main memory 113 and a hard disk drive (HDD) 112.

The main CPU 101, which corresponds to the main controller 20 of FIG. 2, controls entire operation of the image forming apparatus 1, such as various devices including the controller 10 and the engine 11. For example, according to a user instruction input through the operation panel 12, the main CPU 21 controls operation of copying, printing, scanning, etc., according to the application 17. In printing, the controller 10 receives print data in print description language (PDL) from the communication controller 9 from the outside apparatus such as a PC, and analyzes the PDL data to perform printing to output a printed image.

The operation panel I/F 104 functions as the display controller 16, which controls interaction between the operation panel 12 and the main CPU 21.

The controller 10 is provided with a plurality of modules such as the module A 102 and the module B 103 to perform various operations. Examples of module include, but not limited to, an interface with a removable recording memory such as a USB memory, an Ethernet interface, an ADF controller, and an image processing module that controls image rotation or image editing.

The nonvolatile memory 105 stores various data including, for example, settings data that may be customized by the user, and a number of images to be printed. The jam removal instruction may be stored in the nonvolatile memory 105, or any desired memory, to be referred by the main CPU 101.

The interruption controller 109 includes a register that turns on an element corresponding to an interrupted block, and notifies the CPU 26 of the interrupted block. In this example, the block corresponds to each element in the hardware structure of FIG. 3.

The sub CPU 106 controls switching of an operation mode, such as switching to or from an energy save mode. For example, based on a timer value output from a timer, the sub CPU 106 determines a specific operation mode of the image forming apparatus 1, and controls electric power supply to one or more blocks according to the operation mode.

The HDD I/F 107 controls data to be transmitted or received between the HDD 112 and the main CPU 101. The HD 112 stores therein various programs (program) 114. The program 114 may be previously stored in the HDD 112, or downloaded onto the HDD 112 from a network. In this example, the instruction output control program is stored in the HDD 112. Upon execution, the CPU 101 loads the instruction output control program from the HDD 112 onto a memory to cause the controller 10 to have a functional structure of FIG. 2 such as the user location detector 21 and the jam removal instruction controller 22.

The PCI I/F 108 controls data to be transmitted or received between the engine 11 and the main CPU 101, using PCI express.

The DDR controller 110 writes onto or reads from the main memory 113. In writing, the DDR controller 110 writes data obtained from any device as instructed by the main CPU 101, into an address of the main memory 33. In reading, the DDR controller 110 reads data from an address of the main memory 33 as instructed by the main CPU 101, and outputs the read data to any device. The main memory 113 may be implemented by any desired memory such as SDRAM. The various data to be used by the main CPU 101, such as sensor outputs, may be stored in the main memory 113.

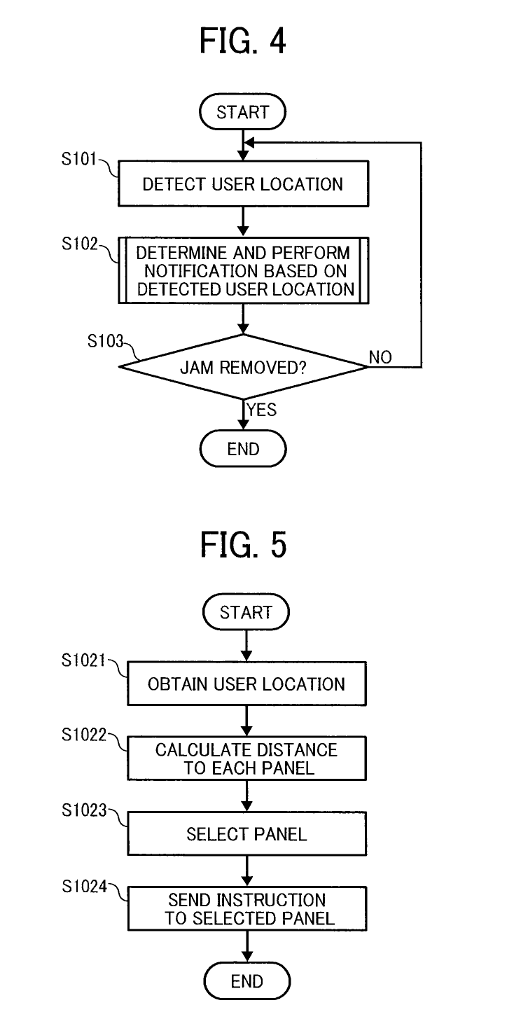

Referring now to FIG. 4, operation of controlling a method of providing an instruction to remove a jam, performed by the image forming apparatus 1, is explained according to an example embodiment of the present invention. The operation of FIG. 4 is performed by the controller 10, when a jam is detected at the image forming system 100.

At S101, the user location detector 21 of the main controller 20 detects the current location of the user who operates the image forming system 100. In one example, the user location detector 21 may detect the current user location, based on data output from the sensor 14 through the sensor controller 19 and/or the sensor 44 through the sensor controller 49. In another example, the user location detector 21 may detect the current user location, based on data indicating opening or closing of the cover 13 that is received through the operation detector 18 or data indicating opening or closing of the cover 43 that is received through the operation detector 48. In another example, the user location detector 21 may detect the current user location, based on data output from the operation panel 12 through the display controller 16 or data output from the operation panel 42 through the display controller 46. In another example, assuming that the operation panel 12 is taken out from the body of the image forming apparatus 1, the user location detector 21 may detect the current user location based on the current location of the operation panel 12 that is received through the display controller 16.

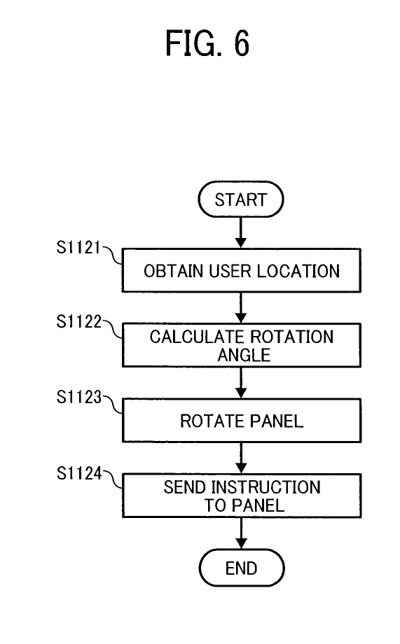

At S102, the jam removal instruction controller 22 determines a method of instructing a jam removal procedure, i.e., a jam removal instruction method, based on the current user location detected by the user location detector 21. In one example, the jam removal instruction controller 22 may select one of the operation panels 12 and 42 to be used for outputting the jam removal instruction to the user, based on the current location of the user, which will be described below referring to FIG. 5. In another example, the jam removal instruction controller 22 may change the angle of the operation panel 12 to be used for outputting the jam removal instruction to the user, based on the current location of the user, which will be described below referring to FIG. 6.

At S103, the jam removal instruction controller 22 determines whether all jammed paper are removed. For example, the jam removal instruction controller 22 may determine whether all jammed paper are removed, based on the sensor output indicating the presence or absence of jammed paper. When it is determined that all jammed paper are removed (“YES” at S103), the operation ends. When it is determined that all jammed paper are not removed (“NO” at S103), the operation returns to S101 to repeat operation of FIG. 4 until all jams are removed.

Referring now to FIG. 5, example operation of determining a jam removal instruction method, which is performed at S102 of FIG. 4, is explained. In this example, one of the operation panel 12 and the operation panel 42 is selected based on the current user location.

At S1021, the jam removal instruction controller 22 obtains the current user location from the user location detector 21.

At S1022, the jam removal instruction controller 22 calculates a distance between the current user location and the location of the operation panel, for each one of the operation panels 12 and 42.

At S1023, the jam removal instruction controller 22 selects one of the operation panels 12 and 42, which is located closer to the current user location, using the distance calculated for each one of the operation panels 12 and 42.

At S1024, the jam removal instruction controller 22 sends an instruction to output the jam removal instruction, to the selected operation panel.

Through performing operation of FIG. 5, the operation panel that is located near the user is selected to output the jam removal instruction. With this configuration, the user is prevented from moving all the way to the operation panel to check for the jam removal procedure, in case the current user location is far from the operation panel.

Referring now to FIG. 6, example operation of determining a jam removal instruction method, which is performed at S102 of FIG. 4, is explained. In this example, the angle of the operation panel 12 is changed based on the current user location. Further, it is assumed that only one operation panel 12 is provided for the image forming system 100.

At S1121, the jam removal instruction controller 22 obtains the current user location from the user location detector 21.

At S1122, the jam removal instruction controller 22 calculates a rotation angle of the operation panel 12 to be set. More specifically, the jam removal instruction controller 22 obtains a straight line that passes through the current user location and the operation panel 12, and obtains a desired angle of the operation panel 12 that causes the display screen surface of the operation panel 12 to be perpendicular to the obtained straight line. Once the desired angle is obtained, the jam removal instruction controller 22 calculates a rotation angle of the operation panel 12, based on difference between the desired angle and the current angle of the operation panel 12.

At S1123, the jam removal instruction controller 22 instructs the display controller 16 to rotate the operation panel 12 to have the desired angle, for example, through controlling a motor that rotates the operation panel 12.

At S1124, the jam removal instruction controller 22 sends an instruction to output the jam removal instruction, to the operation panel 12 that has the desired angle.

Through performing operation of FIG. 6, the operation panel is faced towards the user, when outputting the jam removal instruction. With this configuration, the user can easily see the jam removal instruction that is output from the operation panel.

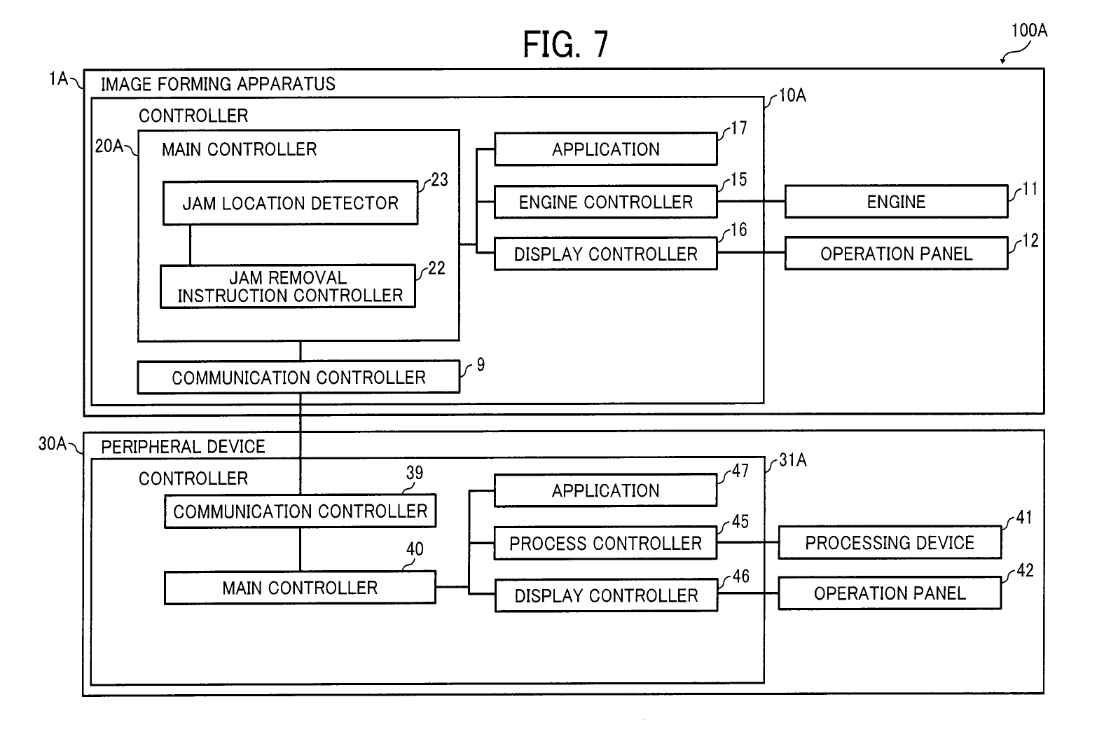

Referring now to FIG. 7, a configuration of an image forming system 100A is explained according to an example embodiment of the present invention.

In the above-described image forming system 100 of FIG. 2, the current user location is detected using, for example, data output from the sensor 14 or 44, or information indicating opening or closing of the cover 13 or 43. In the image forming system 100A of FIG. 7, the current user location is determined to be a location where a jam is detected. When the jam occurs, the user usually moves to the location where the jam is detected, to remove the jammed paper. Based on this assumption, it is determined that the current user location is the location where the jam is detected.

The image forming system 100A includes an image forming apparatus 1A and a peripheral device 30A.

The image forming apparatus 1A is substantially similar to the image forming apparatus 1 of FIG. 2, except that the cover 13, the operation detector 18, the sensor 14, and the sensor controller 19 are not provided. The controller 10A, which has a hardware structure described referring to FIG. 3, includes a main controller 20A provided with a jam location detector 23 and the jam removal instruction controller 22.

The peripheral device 30A, such as the sheet feeding device 31 or the post processing devices 32 to 34, is substantially similar to the peripheral device 30 of FIG. 2, except that the cover 43, the operation detector 48, the sensor 44, and the sensor controller 49 are not provided. More specifically, the peripheral device 30A includes a controller 31A, the processing device 41, and the operation panel 42.

The jam location detector 23 detects the location where the jam is detected, for example, based on information regarding the jam from the engine 11 through the engine controller 15 or information regarding the jam from the sensor that detects the presence of jammed paper. In alternative to the above-described jam location detection method, the location where the jam occurs may be detected using any other desired method. The jam location detector 23 sends the detected jam location to the jam removal instruction controller 22.

The jam removal instruction controller 22, which receives the detected jam location, selects a method of instructing a jam removal procedure, based on the detected jam location that is assumed to reflect the current user location. The jam removal instruction controller 22 further causes the display controller 16 to output a jam removal instruction using the selected instruction method. In this example, it is assumed that the jam removal instruction is given to the user, one step by one step, in an order previously determined based on a priority assigned to each step.

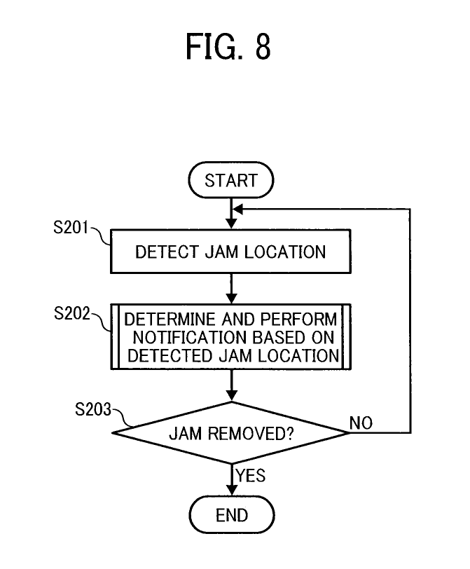

Referring now to FIG. 8, operation of controlling a method of providing an instruction to remove a jam, performed by the image forming apparatus 1A, is explained according to an example embodiment of the present invention. The operation of FIG. 8 is performed by the controller 10A, when a jam is detected at the image forming system 100A.

At S201, the jam location detector 23 of the main controller 20A detects the current jam location where the jam occurs, as information that reflects the current user location.

At S202, the jam removal instruction controller 22 determines a method of instructing a jam removal procedure, i.e., a jam removal instruction method, based on the jam location detected by the jam location detector 23. In one example, the jam removal instruction controller 22 may select one of the operation panels 12 and 42 to be used for outputting the jam removal instruction to the user, based on the jam location, as described above referring to FIG. 5. In another example, the jam removal instruction controller 22 may change the angle of the operation panel 12 to be used for outputting the jam removal instruction to the user, based on the jam location, as described above referring to FIG. 6.

At S203, the jam removal instruction controller 22 determines whether all jammed paper are removed. When it is determined that all jammed paper are removed (“YES” at S203), the operation ends. When it is determined that all jammed paper are not removed (“NO” at S203), the operation returns to S201 to repeat operation of FIG. 8 until all jams are removed.

As described above referring to FIGS. 7 and 8, in the image forming system 100A of FIG. 7, the operation panel that is located near the user is selected to output the jam removal instruction, based on assumption that the user is most likely to move to the location where the jam is detected, without requiring detection of the current user location.

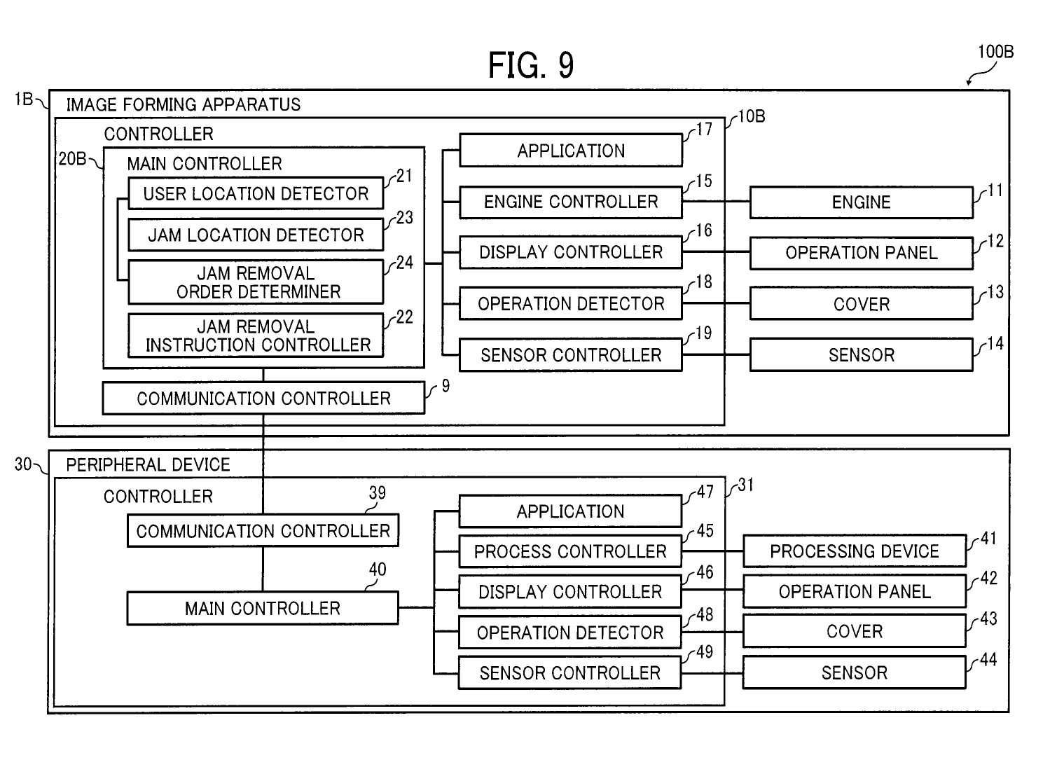

Referring now to FIG. 9, a configuration of an image forming system 100B is explained according to an example embodiment of the present invention.

In the above-described image forming system 100 of FIG. 2 and the image forming system 100A of FIG. 7, the jam removal instruction is to be given to the user, one step by one step, in a predetermined order based on a priority assigned to each step. For example, the image forming apparatus 1 or 1A stores a plurality of jam removal instructions, each indicating specific steps to be performed to remove a jam that has been detected at a specific jam location. Using the jam location, a specific jam removal instruction is selected and the steps are displayed through the operation panel in a predetermined order.

In this image forming apparatus 1B of FIG. 9, the order in displaying the steps in the jam removal instruction may be changed, based on the current user location, the jam location, and a configuration of the image forming system 100B.

Further, in the above-described image forming system 100 of FIG. 2 and the image forming system 100A of FIG. 7, when there is more than one jam that has been detected, a plurality of sets of jam removal instructions is given to the user, one instruction by one instruction, in a predetermined order based on a priority assigned to each jam removal instruction. In this image forming apparatus 1B of FIG. 9, the order in displaying the jam removal instructions may be changed, based on the current user location, the jam location, and the configuration of the image forming system 100B.

More specifically, when a jam occurs at more than one location of the image forming system 100B, the user may need to keep moving from one location to another location, to take out jammed paper from a plurality of locations. In view of this, the image forming apparatus 1B determines the most appropriate order in removing the jammed paper from the plurality of jam locations, based on the current user location, the jam location, and the configuration of the image forming system 100B. By controlling an order in displaying the jam removal instructions according to the user location and the jam location in addition to the configuration of the image forming system 100B, the distance between the user location and the jam location of a jam to be processed next can be made smaller, thus preventing the user from walking a long distance.

The image forming system 100B of FIG. 9 includes the image forming apparatus 1B and the peripheral device 30. The image forming apparatus 1B is substantially similar to the image forming apparatus 1 of FIG. 2, except that the jam location detector 23 and the jam removal order determiner 24 are additionally provided in the main controller 20B of the controller 10B.

The main controller 20B includes the user location detector 21 that detects the current user location, the jam location detector 23 that detects the jam location, the jam removal order determiner 24 that determines a jam removal order based on the current user location detected by the user location detector 21, the jam location detected by the jam location detector 23, and the configuration of the image forming system 100B.

The jam removal instruction controller 22, which receives the determined jam removal order, identifies a jam to be processed next based on the determined jam removal order, and selects a method of instructing a jam removal procedure for the jam to be processed next based on the current user location and/or the jam location. The jam removal instruction controller 22 further causes the display controller 16 to output a jam removal instruction using the determined jam removal instruction method.

In example operation, the jam location detector 23 detects one or more jam locations, based on information indicating the occurrence of jams that is received from the engine 11 through the engine controller 15 or sensor outputs indicating the presence of jammed paper.

The jam removal order determiner 24 determines whether there is more than one jam location that has been detected by the jam location detector 23. When it is determined that there is more than one jam location, the jam removal order determiner 24 determines a jam location to be processed next (such as the jam location to be firstly processed), that is, a jam removal instruction to be displayed next (such as firstly displayed) to the user, based on various types of data including the current user location, the jam location, and/or the configuration of the image forming system 100B.

In one example, the jam removal order determiner 24 may determine an order in displaying the jam removal instructions to remove jams, based on the detected jam location, the current user location, and the configuration of the image forming system 100B. The configuration of the image forming system 100B is considered, so as to prevent any damage to the device of the image forming system 100B or to prevent the jammed paper from being ripped. For example, each jam removal instruction may be assigned with a priority order in displaying, and information indicating whether change of an order is permitted, based on the configuration of the image forming system 100B. With this information, the jam removal order determiner 24 is able to determine that which one of the jam removal instructions to be displayed is restricted from changing the order in displaying.

For example, the jam removal order determiner 24 may identify one or more jam locations that cannot be processed next or its order cannot be changed, due to the risk in damage to jammed paper or the device of the image forming system 100. The jam removal order determiner 24 may generate a list of jam locations from which jammed paper is to be removed, while excluding the identified jam locations that cannot be processed next. The jam removal order determiner 24 calculates a distance between the current user location that is detected by the user location detector 21, and the jam location, for each one of the jam locations that are listed. Based on the distance, the jam removal order determiner 24 determines an order in displaying the jam removal instructions, such that the jam removal instructions are given in an order from the jam location closer to the current user location, to the jam location away from the current user location.

In another example, the order in displaying the jam removal instructions may be determined based on user preference. For example, before determining the order in displaying the jam removal instructions, the jam removal order determiner 24 may identify one or more jam locations that cannot be processed next due to the risk in damage to jammed paper or the device of the image forming system 100. The jam removal order determiner 24 may generate a list of jam locations from which jammed paper is to be removed, while excluding the identified jam locations that cannot be processed next or its order cannot be changed. The jam removal order determiner 24 may cause the display controller 16 to display the generated list of jam removal instructions that can be processed next, on the operation panel 12, for selection by the user. Based on the user selection, the jam removal order determiner 24 may determine an order in displaying the jam removal instructions, such as the jam removal instruction to be displayed next. In such case, the current user location does not have to be obtained. When it is to be obtained, the image forming apparatus 100B may detect the current user location, when inquiring the user about the jam to be processed next. When the jammed paper is removed from the jam location, the jam removal order determiner 24 repeats the above-described processes of displaying a list of jam locations to be processed next, selecting a jam location to be processed next based on the user selection, displaying the jam removal instruction for the selected jam location, and determining whether the jam is removed, until all jams are removed.

The jam removal instruction controller 22 determines a jam removal instruction method for each one of the jam removal instructions, in the order in displaying the jam removal instructions that is determined by the jam removal order determiner 24. The jam removal instruction method may be determined in various ways, as described above for the example cases of the image forming system 100 of FIG. 2 and the image forming system 100A of FIG. 7.

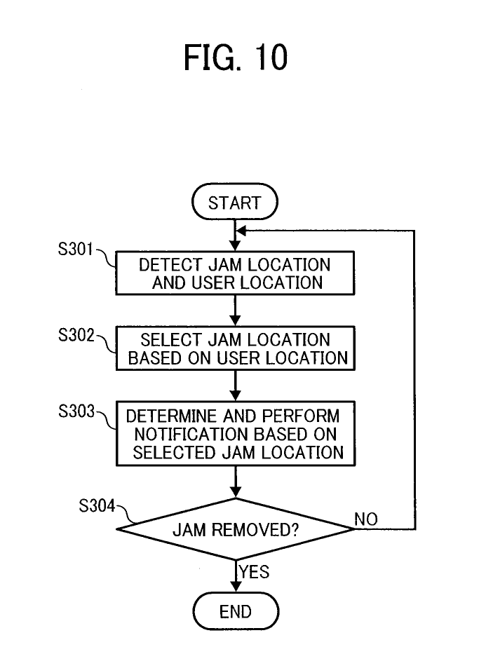

Referring now to FIG. 10, operation of controlling a method of providing an instruction to remove a jam, performed by the image forming apparatus 1B, is explained according to an example embodiment of the present invention. The operation of FIG. 10 is performed by the controller 10B, when a jam is detected at the image forming system 100B.

At S301, the jam location detector 23 of the main controller 20B detects the current jam location where the jam occurs. The user location detector 21 detects the current user location of the user who operates the image forming system 100B.

Assuming that more than one jam is detected, the operation proceeds to S302. At S302, the jam removal order determiner 24 determines the jam location to be processed next, based on the jam location and the current user location. As described above, the configuration of the image forming system 100B may be considered.

At S303, the jam removal instruction controller 22 determines a method of instructing a jam removal procedure, i.e., a jam removal instruction method, to remove the jam at the jam location to be removed next, based on the determined jam location and/or the current user location.

At S304, the jam removal instruction controller 22 determines whether all jammed paper are removed. When it is determined that all jammed paper are removed (“YES” at S304), the operation ends. When it is determined that all jammed paper are not removed (“NO” at S304), the operation returns to S301.

In alternative to automatically selecting the location of the jam to be removed next, out of a plurality of jam locations, the image forming apparatus 1B may allow the user to select the jam location to be processed next or an order of processing the jam locations. In such case, S301 of detecting the current user location is not necessary. More preferably, the image forming apparatus 1B may detect the current location of the user, when inquiring the user to input information regarding the jam location to be processed next.

Through performing operation of FIG. 10, the order of giving the jam removal instructions is determined based on the user location and the jam location, so as to suppress the user from walking a long distance to see the jam removal instruction or to take out jammed paper.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, any of the above-described devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In one example, the present invention may reside in an image forming apparatus that controls operation of one or more peripheral devices connected to the image forming apparatus. The image forming apparatus includes: a first display that displays information regarding at least the image forming apparatus; a user location detector that detects a current location of a user who is present near the image forming apparatus or the peripheral devices, when a jam is detected at the image forming system; and an instruction controller that determines a method of outputting a jam removal instruction to the user through the first display based on the current user location, and causes the first display to display the jam removal instruction according to the determined jam removal instruction method.

What is claimed is:

1. An image forming system, comprising:
an image forming apparatus configured to form an image on a recording sheet; and
one or more peripheral devices connected to the image forming apparatus,
wherein the image forming apparatus includes:
a first display that displays information regarding at least the image forming apparatus;
a user location detector that detects a current location of a user who is present near the image forming apparatus or the peripheral devices, when a jam is detected at the image forming system; and
an instruction controller that determines a method of outputting a jam removal instruction to the user through the first display based on the current user location, and causes the first display to display the jam removal instruction according to the determined jam removal instruction method.

2. The image forming system of claim 1, wherein the one or more peripheral devices include at least one of:
a sheet feeding device that has a recording sheet storage capacity larger than a recording sheet storage capacity of the image forming apparatus, and that feeds the recording sheet to the image forming apparatus for image formation; and
a post processing device that performs post processing on the recording sheet having the image formed by the image forming apparatus.

3. The image forming system of claim 1, wherein at least one of the one or more peripheral devices includes a second display that displays information regarding at least the peripheral device, and
the instruction controller of the image forming apparatus selects one of the first display and the second display, which has a distance that is closer to the current user location detected by the user location detector, and causes the selected one of the first display and the second display to display the jam removal instruction.

4. The image forming system of claim 1, wherein the first display is rotatable to change the angle that a display screen faces, and
the instruction controller of the image forming apparatus rotates the first display to change the angle of the display screen so as to face the current user location.

5. The image forming system of claim 1, wherein the first display is provided with a sound output device that outputs information by voice navigation, and
the instruction controller causes the sound output device of the first display to output the jam removal instruction by voice navigation, when a distance between the current user location and the location of the first display is greater than a threshold value.

6. The image forming system of claim 1, wherein the user location detector detects the current user location, based on at least one of:
data indicating the human presence that is detected by a sensor of the image forming apparatus or a sensor of the peripheral device;
data indicating opening or closing of a cover of the image forming apparatus or a cover of the peripheral device; and
data indicating the current location of the first display, when the first display is removable from the body of the image forming apparatus.

7. The image forming system of claim 1, wherein the image forming apparatus further includes a jam location detector that detects a location of the image forming system where the jam is detected, and
the instruction controller receives the jam location as information that reflects the current user location, and determines the jam removal instruction method based on the jam location without requiring information from the user location detector.

8. The image forming system of claim 1, wherein the image forming apparatus further includes:
a jam location detector that detects a location of the image forming system where the jam is detected; and
a jam removal order determiner that determines, when a plurality of jams is detected at a plurality of jam locations, an order in outputting a plurality of jam removal instructions to remove the plurality of jams, based on the jam location, the current user location, and a configuration of the image forming system,
wherein the instruction controller causes the first display to display the plurality of jam removal instructions in the order determined by the jam removal order determiner.

9. A method of controlling output of a jam removal instruction, the method comprising:
obtaining information indicating detection of a jam at an image forming system including an image forming apparatus and one or more peripheral devices;
detecting a current location of a user who is present near the image forming apparatus or the peripheral devices;
determining a method of outputting a jam removal instruction to the user through a first display of the image forming apparatus based on the current user location; and
causing the first display to display the jam removal instruction according to the determined jam removal instruction method.

10. The instruction output control method of claim 9, wherein the determining a method of outputting a jam removal instruction includes:
selecting one of the first display of the image forming apparatus, and a second display of the peripheral devices, which has a distance that is closer to the current user location; and
causing the selected one of the first display and the second display to display the jam removal instruction.

11. The instruction output control method of claim 9, wherein the determining a method of outputting a jam removal instruction includes:
rotating the first display to change the angle that a display screen of the first display faces, so as to face the current user location.

12. The instruction output control method of claim 9, wherein the determining a method of outputting a jam removal instruction includes:
calculating a distance between the current user location and the location of the first display; and
causing a sound output device of the first display to output the jam removal instruction by voice navigation, when the calculated distance is greater than a threshold value.

13. The instruction output control method of claim 9, further comprising:
detecting a location of the image forming system where the jam is detected;
receiving the jam location as information that reflects the current user location; and
determining the jam removal instruction method based on the jam location without requiring information indicating the current user location.

14. The instruction output control method of claim 9, further comprising:
detecting a location of the image forming system where the jam is detected;
determining whether a plurality of jams is detected at a plurality of jam locations;
determining an order in outputting a plurality of jam removal instructions to remove the plurality of jams when the plurality of jams is detected, the order being determined based on the jam location, the current user location, and a configuration of an image forming system; and
causing the first display to display the plurality of jam removal instructions in the determined order.

15. A non-transitory recording medium which, when executed by a processor, cause the processor to perform a method of controlling output of a jam removal instruction, the method comprising:
obtaining information indicating detection of a jam at an image forming system including an image forming apparatus and one or more peripheral devices;
detecting a current location of a user who is present near the image forming apparatus or the peripheral devices;
determining a method of outputting a jam removal instruction to the user through a first display of the image forming apparatus based on the current user location; and
causing the first display to display the jam removal instruction according to the determined jam removal instruction method.
